(19) United States
(12) Patent Application Publication
(10) Pub. No.: US 2011/0131003 A1
(43) Pub. Date: Jun. 2, 2011

(54) Vibration logging in computers

(75) Inventor: Oystein Tusvik, Torp (NO)

(73) Assignee: SAFE INNOVATIONS AS, Sellebakk (NO)

(21) Appl. No.: 12/935,916

(22) PCT Filed: Apr. 2, 2009
(86) PCT No.: PCT/NO2009/000129

§ 371 Date: Feb. 15, 2011

Related U.S. Application Data
(60) Provisional application No. 61/042,284, filed on Apr. 4, 2008.

(30) Foreign Application Priority Data
Apr. 4, 2008 (NO) 20081670

(51) Int. Cl. G01K 1/00; G06F 19/00; G01N 5/02; G01N 21/59; G01P 15/00

(52) U.S. Cl. 702/130; 702/184; 73/73; 356/438; 702/141

(57) ABSTRACT

The invention relates to a process and a monitoring device for monitoring an equipment unit, carried out by a processing device in the monitoring device. The process comprises reading at least one sensor signal and determining, on the basis of the at least one sensor signal, whether the equipment unit has been subjected to an unacceptable stress. If the equipment device has been subjected to an unacceptable stress, a start-up lock for the equipment unit is enabled, and lock status information is stored. The step of determining whether the equipment unit has been subjected to an unacceptable stress may comprise criteria that are dependent upon whether the monitoring device is operating in a low-power mode or a normal power mode. When a signal is received that indicates that the equipment unit is to be started up, it is determined whether the start-up lock has been enabled. If it has been enabled, a warning is activated. If, in addition, a non-reversible switch has not been activated, the warning is maintained and further operation of the equipment unit is prevented.

### FIELD OF THE INVENTION

The present invention relates to the automatic monitoring of equipment such as computers.

Specifically, the invention relates to a process for monitoring an equipment unit, a corresponding set of processing instructions, a corresponding monitoring device and an equipment unit comprising such a monitoring device

### BACKGROUND OF THE INVENTION

There is a general need to monitor equipment, particularly electronic equipment such as computers, and especially servers, before and after the equipment has been put into operation.

There is a particular need to monitor the equipment in a period from it leaving the manufacturer until a time during its operating phase, especially when the guarantee period has expired.

Furthermore, there is a need to document that the equipment has been subjected to certain external events in different phases of this period, and there is a need to initiate measures as a consequence of the events that have taken place.

US-2006/0184379 teaches a previously known system for collecting and analysing data from sensors contained within electronic products, with a view to dealing with warranty issues. However, it cannot be seen that this previously known solution involves the prevention of possibly damaged equipment from being started up.

### BRIEF DESCRIPTION OF THE INVENTION

In accordance with the present invention, there is provided a computer-implemented process and a device as disclosed in the attached independent claims.

Advantageous embodiments of the invention are set forth in the dependent claims.

Additional features and principles of the present invention will be understood from the detailed description below.

It should be appreciated that both the above general description and the following detailed description are given by way of example and for explanatory purposes. They are not limiting for the invention as disclosed in the claims.

### BRIEF DESCRIPTION OF THE DRAWINGS

The attached drawings illustrate a preferred embodiment of the invention. In the drawings

FIG. 1 is an exemplary block diagram illustrating general principles of an equipment unit provided with a monitoring device in accordance with the invention.

FIG. 2 is an exemplary flow chart illustrating the principles of a process in accordance with the invention.

FIG. 3 is an exemplary flow chart illustrating the principles of a process in accordance with the invention, especially for low-power operation.

FIG. 4 is an exemplary flow chart illustrating the principles of a process in accordance with the invention, especially for normal power operation.

FIG. 5 is an exemplary flow chart illustrating further principles of a process in accordance with the invention.

FIG. 6 is an exemplary block diagram which, in more detail, illustrates the principles of an exemplary embodiment of a monitoring device in accordance with the invention.

FIG. 7 is an exemplary block diagram which, in more detail, illustrates the principles of a non-reversible switch.

### DETAILED DESCRIPTION OF THE INVENTION

Detailed reference is now made to the present invention, examples of which are illustrated in the attached drawings. Wherever possible, the same reference numerals will be used throughout the drawings to refer to the same or like parts.

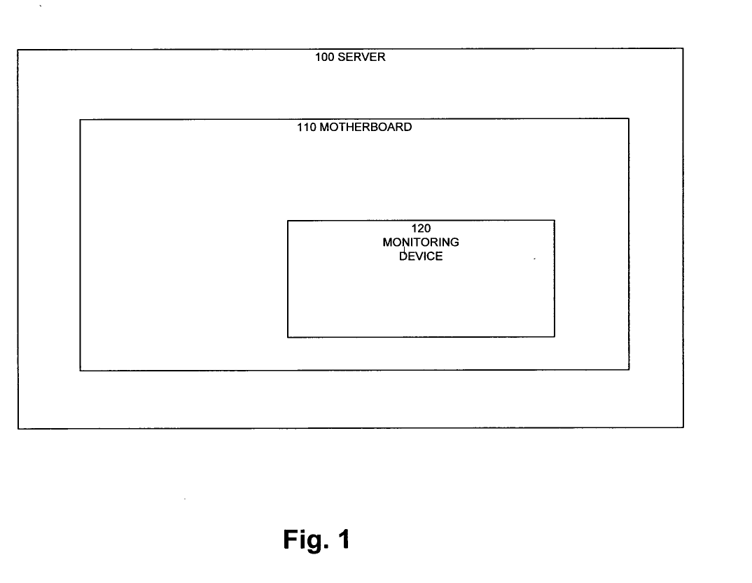

FIG. 1 is an exemplary block diagram illustrating general principles of an equipment unit provided with a monitoring device in accordance with the invention.

The equipment unit 100 may, in one example, be a computer such as a server. Alternatively, the equipment unit may be a computer of another type, e.g. a work station, a personal computer, in particular of the stationary type, or, as an alternative, of the portable type. Alternatively, the equipment unit may be other electronic equipment, such as a network element (a router, a switch, a bridge, a hub, a gateway, a firewall, a modem, or the like). Further alternatives include medical equipment, measuring equipment, automation equipment and so forth.

The equipment unit 100 comprises an equipment element 110, which in one example may be a printed circuit board such as a motherboard.

Alternatively, the equipment element 110 may be another printed circuit board arranged in the equipment unit 100, or the equipment element may be any element included in the equipment unit 100, in particular an element which is subjected to external stresses such as shocks, impacts or the like. In particular, the equipment element 110 is of a type that may cause functional failure, or other costly or dangerous consequences as a result of external factors.

A monitoring device 120 is arranged on the equipment element 110, such as the motherboard. The monitoring device 120 is adapted to monitor the state of the equipment unit 100, in particular the equipment element 110. For this purpose, the monitoring device is designed to carry out a process in accordance with the present specification.

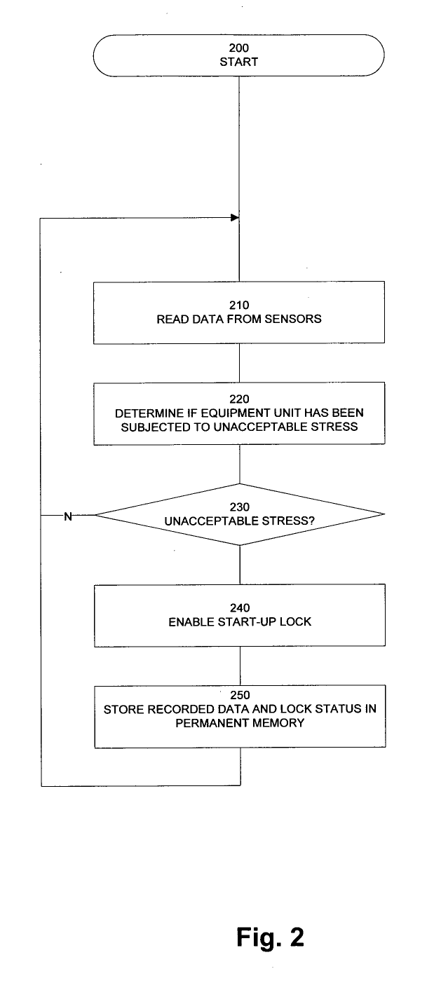

FIG. 2 is an exemplary flow chart illustrating the principles of a process in accordance with the invention.

The illustrated process can be carried out by a processing unit contained within the monitoring device 120.

In one specific embodiment, the equipment unit 100 is a computer, in particular a server, and the monitoring unit 120 is installed on a printed circuit board, in particular a motherboard, or alternatively another printed circuit board, in the server/computer.

The process starts at the first step 200.

Further, in step 210, a sensor signal from at least one sensor is input. The at least one sensor is of a type that makes it possible to decide whether the equipment unit has been subjected to an unacceptable stress.

In one embodiment, the at least one sensor is an acceleration sensor. In other embodiments, the at least one sensor comprises at least one additional sensor selected from the group consisting of temperature sensors, humidity/moisture sensors, and optical dust or dirt sensors. Any number of sensors, including one, two, three, four or more, may be used.

Further, in step 220, processing instructions are executed in order to determine whether the equipment unit has been subjected to an unacceptable stress. In one embodiment, this comprises ascertaining whether the sensor signal, for example, the acceleration sensor signal, exceeds a limit value contained within a memory, e.g., comparing the sensor signal and the limit value.

Further, in step 230, it is determined whether the equipment unit has been subjected to an unacceptable stress. If this is not the case, the process is repeated from the step 210 of inputting a sensor signal.

However, if in step 230 it is determined that the equipment unit has been subjected to an unacceptable stress, step 240 is carried out.

In this context “unacceptable stress” should be understood to mean an external stress which indicates that the equipment unit has been subjected to a treatment or has been in an environment which does not conform to given criteria, for example, parameters given by the manufacturer in connection with guarantee conditions or parameters determined by safety requirements.

As a non-limiting example, it may be determined in one embodiment that the equipment unit has been subjected to an unacceptable stress if a signal from an acceleration sensor indicates an acceleration greater than an acceleration limit, where the acceleration limit is in the range [10G, 30G], more advantageously in the range [15G, 25G] and especially advantageously in the range [18G, 22G].

Other possible tests for determining if the equipment unit has been subjected to an unacceptable stress, include determining if a temperature sensor signal exceeds a particular limit value stored in a memory, determining if a humidity or moisture sensor signal exceeds a particular limit value stored in a memory, and determining if a dust or dirt sensor signal exceeds a particular limit value stored in a memory. Other possible tests for determining if the equipment unit has been subjected to an unacceptable stress, utilizing more than one sensor type, include any combination of the above mentioned tests.

It should be understood that steps 210, 220 and 230 are indicated as a sequential loop only for explanatory purposes, and that the invention is not limited to this.

In step 240 a start-up lock, i.e., a device or function that prevents the equipment unit 100 from being started up, is enabled.

Further, in step 250, recorded data from the input sensor signals is stored in a memory in the monitoring device 120. The data stored may be unprocessed, sampled and digitised sensor data, and/or processed/derived data, and/or a selection of these data. Advantageously, the data is stored structured and together with data representing real time (date, time) for the data collection. Status for the start-up lock, i.e., data indicating whether the start-up lock has been enabled or not, is also stored in the memory. In one embodiment, the aforementioned data is stored in step 250 in a non-volatile or permanent memory, e.g., a Flash memory.

After step 250, the process may continue with a new input from sensors, i.e., the process is repeated from step 210.

Although it is not specifically illustrated in the basic flow chart in FIG. 2, the process can be interrupted or ended as and when required.

In one embodiment, the process comprises a further step for determining whether the monitoring device is to operate in a low-power mode or a normal power mode.

In a low-power mode, the monitoring device 120 is powered typically by a battery.

In a normal power mode, the monitoring device 120 typically has access to power from an external power supply, and it is therefore operated on power supplied from the external power supply.

As mentioned above, step 220, in which it is determined whether the equipment unit has been subjected to an unacceptable stress, may in such an embodiment comprise criteria that are dependent upon whether the monitoring device is operating in a low-power mode or a normal power mode.

This may, for example, involve that in a low-power mode one type of sensor signal or one set of sensor signals is used in determining whether the equipment unit has been subjected to an unacceptable stress, whilst in a normal power mode another type of sensor signal or another set of sensor signals is used to determine whether the equipment unit has been subjected to an unacceptable stress.

As an illustrative example, in a low-power mode it may be determined that the equipment unit has been subjected to an unacceptable stress if an acceleration sensor signal exceeds a limit value, whilst in a normal effect mode it is determined that the equipment unit has been subjected to an unacceptable stress if the acceleration sensor signal exceeds the limit value, in addition to signals from other sensors such as temperature sensor(s), humidity/moisture sensor(s) and/or optical dirt/dust sensor(s).

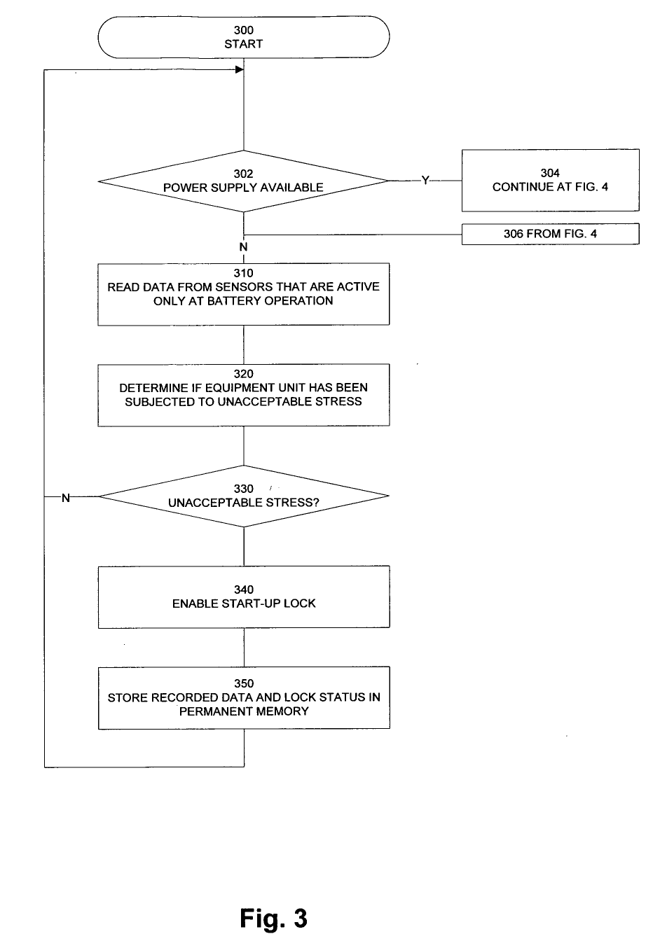

FIG. 3 is an exemplary flow chart illustrating the principles of a process in accordance with the invention, in particular for low-power operation.

This embodiment of the process starts at the first step 300.

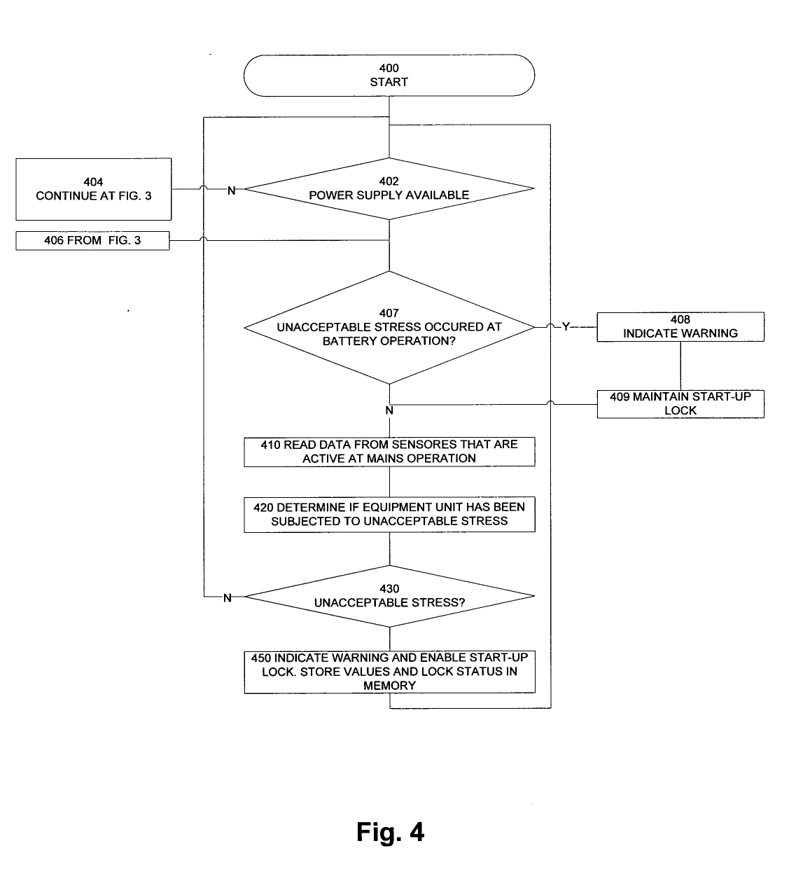

In step 302 it is determined whether external power supply is available. This can be determined on the basis of the presence of voltage on an input terminal connected to the external power supply. If voltage is present, the process illustrated in FIG. 4 and discussed below in the description is carried out. This is illustrated schematically at step 304—go to FIG. 4, and step 306—from FIG. 4.

Steps 302, 304 and 306 have been included for explanatory and illustrative purposes. The other elements in FIG. 3 indicate the steps that are carried out in a low-power mode. It should be understood that the switching between low-power mode and normal power mode alternatively can take place in a parallel process which has the task of switching between these modes, on the basis of the availability of the external power supply.

Further, in step 310, a sensor signal from at least one sensor is input. The at least one sensor is of a type that makes it possible to decide whether the equipment unit has been subjected to an unacceptable stress. This corresponds, in principle, to step 210 shown in FIG. 2. However, step 310 may comprise input of a type of sensor signal particularly suitable for a low-power mode, such as only an acceleration signal from a sensor with minimum power consumption. In another embodiment, suitable for especially low power consumption, the sensor signal may be a signal from a tilt sensor, for example a mercury switch.

Further, in step 320, processing instructions are executed in order to determine whether the equipment unit has been subjected to an unacceptable stress. In the case of an acceleration sensor, this includes ascertaining whether the acceleration sensor signal exceeds a limit value contained within a memory, e.g., comparing the sensor signal and the limit value.

Further, in step 330, it is determined whether the equipment unit has been subjected to an unacceptable stress. If this is not the case, the process is repeated from the step 210 of inputting a sensor signal.

If, on the other hand, it is determined in step 330 that the equipment unit has been subjected to an unacceptable stress, step 340 is carried out.

“Unacceptable stress” and steps 320 and 330 should be understood in the same way as for steps 220 and 230 disclosed in the description of FIG. 2.

In step 340 (as in step 240) a start-up lock, i.e., a device or function that prevents the equipment unit 100 from being started up, is enabled.

Further, in step 350 (as in step 250), recorded data from the input sensor signals is stored in a memory in the monitoring device 120. The data stored may be unprocessed, sampled and digitised sensor data, and/or processed/derived data, and/or a selection of these data. Advantageously, the data is stored structured and together with data representing real time (date, time) for the data collection. The status of the start-up lock, i.e., data indicating whether the start-up lock has been enabled or not, is also stored in the memory. In one embodiment, the aforementioned data is stored in step 350 in a non-volatile or permanent memory, e.g., Flash memory.

After step 350, the process can continue (as shown) with a repetition from step 302, or alternatively with a new input from sensors, i.e., repetition from step 310.

FIG. 4 is an exemplary flow chart illustrating the principles of a process in accordance with the invention, specifically for normal power operation.

This embodiment of the process starts at the first step 400.

In step 402 it is determined whether external power supply is available. This can be determined on the basis of the presence of voltage on an input terminal connected to the external power supply. If there is no voltage present, the process is instead carried out as illustrated in FIG. 3 and described earlier in the description. This is illustrated schematically at step 404—go to FIG. 3, and step 406—from FIG. 3.

Steps 402, 404 and 406 have been included for explanatory and illustrative purposes. The other elements in FIG. 4 indicate the steps that are carried out in normal power mode. It should be understood that the switching between low-power mode and normal power mode may alternatively take place by a parallel process which has the task of switching between these modes on the basis of the availability of the external power supply.

Furthermore, in step 407, it is determined whether there has been an unacceptable stress on the equipment unit 100 during an earlier low-power mode. This can be done by inputting data which is stored in the memory, in particular data indicating whether the start-up lock has been enabled or not, as described in step 350 above.

If—in normal power mode—in step 407 it is ascertained that there has been an unacceptable stress during low-power mode, step 408, in which a warning is given, is carried out.

Further, step 409 is carried out in which the enabled start-up lock, which prevents the equipment unit 100 from being started up, is maintained.

Further, in step 410, a sensor signal from at least one sensor is input. The at least one sensor is of a type that makes it possible to decide whether the equipment unit has been subjected to an unacceptable stress. This corresponds, in principle, to step 210 shown in FIG. 2. However, step 410 may include the input of other types of sensor signals, particularly suitable for normal power mode, as for example signals from other sensors such as temperature sensor(s), humidity/moisture sensor(s) and/or optical dirt/dust sensor(s) in addition to acceleration sensor(s).

Further, in step 420, processing instructions are executed in order to determine whether the equipment unit has been subjected to an unacceptable stress. In the case of an acceleration sensor, this comprises ascertaining whether the acceleration sensor signal exceeds a limit value contained within a memory, e.g., comparing the sensor signal and the limit value.

Further, in step 430 it is determined whether the equipment unit has been subjected to an unacceptable stress. If this is not the case, the process (as illustrated) is repeated from step 402, or (alternatively) from the step 410 of inputting sensor signals.

However, if in step 430 it is determined that the equipment unit has been subjected to an unacceptable stress, step 440 is carried out.

“Unacceptable stress” and steps 420 and 430 are to be understood in the same way as for steps 220 and 230 disclosed in the description of FIG. 2.

In step 450 a warning is given, and a start-up lock, i.e., a device or function that prevents the equipment unit 100 from being started up, is enabled.

Further, also in step 450, recorded data from the input sensor signals is stored in a memory in the monitoring device 120, in the same way as described for step 250 in FIG. 2.

After step 450, the process may continue (as shown) with a new execution of step 402, or alternatively a new input from sensors, i.e., repetition from step 410.

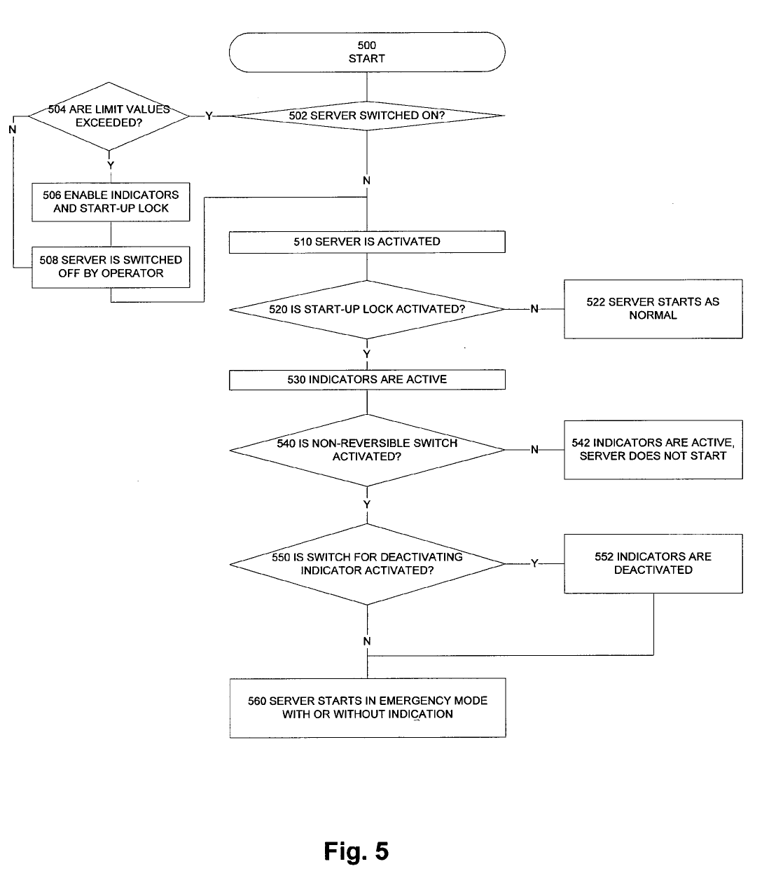

FIG. 5 is an exemplary flow chart illustrating further principles of the process in accordance with the invention.

FIG. 5 shows in particular an illustrative course of events at the start-up or attempted start-up of the equipment unit 100. In FIG. 5 the equipment unit 100 is for the purposes of explanation indicated as a server, but it should be understood that the solution is useful for other types of equipment, as has been stated above.

This embodiment or these additional steps in the process start at the first step 500.

In step 502 it is determined whether the equipment unit is already in operation. If it is, it is investigated in step 504 whether there has been an unacceptable stress, in the same way as in step 230 in FIG. 2. If there has been no unacceptable stress, step 508 is carried out in which the equipment unit 100 is turned off manually by an operator. If there has been an unacceptable stress, a warning and the start-up lock are enabled in step 506, after which step 508 is carried out. After step 508, step 510 is carried out.

Steps 502, 504 and 506 have been included for explanatory and illustrative purposes, especially with the object of showing a way of ensuring that the equipment unit 100 has been deactivated before the further execution of the steps in FIG. 5 from 510 onwards.

Further, in step 510 it is determined that the equipment unit 100 is activated. More specifically, a signal is received that indicates that the equipment unit is to be started up, for example, in that an operator presses a start button on the equipment unit 100.

Further, in step 520 it is determined whether a start-up lock has been enabled. This can be done by inputting data that may have been set in previously mentioned steps (250, 350, 450) regarding lock status. If the start-up lock has not been enabled, step 522 is carried out in which the equipment unit is allowed to start up in the normal manner.

If, on the other hand, it is determined in step 520 that the start-up lock has been enabled, the step 530 of activating a warning is carried out.

Further, step 540 is carried out in which it is determined whether a non-reversible switch has been activated. If the non-reversible switch has not been activated, step 542 is carried out in which the warning is maintained and where the further operation of the equipment unit 100 is still prevented.

If, on the other hand, the non-reversible switch has been activated, step 550 is carried out in which it is further decided whether a switch for deactivating the warning has been activated.

If the switch for deactivating the warning has been activated, step 552, in which the warning is deactivated, is carried out. If, on the other hand, the switch for deactivating the warning has not been activated, step 560, in which the equipment unit 100 is allowed to be started up in a special emergency mode, is carried instead.

The process according to the invention, and as described by way of example with reference to FIGS. 2, 3, 4 and 5, may, by those of skill in the art, and on the basis of the present specification, be implemented as a set of processing instructions. The processing instructions may be provided with the aid of a programming language, such as C++, Java, Perl or the like, and converted into an executable code with the aid of a compiler and/or other programming tool which is well known to those of skill in the art. The resulting instructions may be contained within a memory which may be comprised of the memory in the monitoring device 120.

The instructions may alternatively or additionally be contained within a separate external memory, or be contained within a storage medium such as an optical or magnetic disk, or a semiconductor memory, or it can be carried by a propagated signal, for example, in the form of data packages transmitted over a network such as the Internet. The instructions are designed in such manner that when they are executed by the processing device in the monitoring device 120, they perform a process as exemplified above.

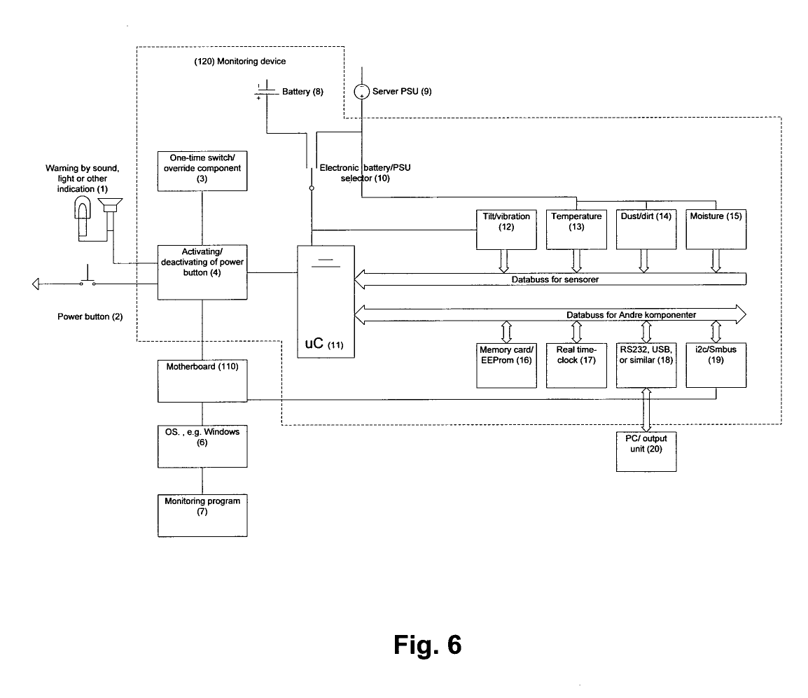

FIG. 6 is an exemplary block diagram illustrating in more detail the principles of an exemplary embodiment of a monitoring device in accordance with the invention.

The monitoring device 120 is indicated within the broken line in FIG. 6.

The monitoring device 120 comprises input circuits, output circuits, a processing device and a memory, connected via at least one bus. The processing device is configured to execute a set of processing instructions as mentioned above, said processor instructions being contained within a memory.

The processing device may, as illustrated, be a microcontroller 11, i.e., a microprocessor with associated elements such as volatile (e.g., RAM) and non-volatile (e.g., Flash, EEPROM) memory, input and output circuits, clock/timing circuits etc. embedded on one and the same chip, typically designed for low power consumption and battery operation. Alternatively, the monitoring device 120 can be implemented with separate circuits for the aforementioned functions.

As shown in FIG. 6, two data buses are connected to the microcontroller—a first data bus (at the top) for sensors and a second data bus (at the bottom) for other components. Alternatively, one and the same data bus, or more buses than the two shown are used for these purposes.

With the aid of a program in the memory, i.e., the set of instructions referred to above, the microcontroller 11 is adapted to analyse data from sensor(s) and to exchange data with the other components which are connected to the data bus(es).

The sensors which are connected to the first data bus comprise, in one embodiment, one or more acceleration sensors 12 (also indicated as tilt/vibration sensor). One or more of these may have their own interrupt outputs to put the microcontroller in normal mode after a sleeping mode.

In addition, the sensors may comprise one or more temperature sensors 13, adapted to measure the temperature of the monitoring device 120 environment, i.e., typically the temperature inside the equipment unit 100. The sensors may further comprise one or more dust/dirt sensors 14 and an air humidity sensor 15.

The purpose of the dust/dirt sensor(s) 14 is to indicate to the monitoring device 120 that the equipment unit 100 may be in danger of being “choked” by dirt. In many places in the world there is a naturally high air humidity. This means that at high levels of air pollution, sticky particles will become attached to the components inside the equipment unit 100. The result of this is that the cooling ribs become choked up. This may also result in “arcing/flashover” between the pins on the electronic circuits, which might generate instability. This is particularly relevant in industrial environments where there are often metal particles from sandblasting, grinding etc. A dust/dirt sensor may, for example, be constructed of an IR diode and an IR receiver. When the light that is registered is substantially reduced or no longer registrable, the diode and the receiver will be covered by such a thick layer of dirt that it will trigger the microcontroller.

As is further evident from FIG. 6, the second data bus—by way of example—is connected to an additional memory 16, a real time clock 17, a serial interface 18 and an additional bus interface 19.

The additional memory 16 may comprise an integral or replaceable memory card, e.g., based on Flash or EEPROM, to safeguard historical sensor data, or a smaller memory area for recording only events that have exceeded the limit values. Such data may alternatively or additionally be integrated in the internal memory of the microcontroller.

The real time clock 17 can in one embodiment be a standard real time clock component (RTC) for supplying data that represents real time (date, time). This can either be constructed as a separate unit, as illustrated, or it can be constituted of an existing circuit contained on the printed circuit board 110, especially the motherboard in the equipment unit 100. The real time clock 17 can use a back-up battery, so that it always has the right date and time. An example of an external version may be DS1307 or the like.

The object of the serial interface 18 is to provide communication with an external unit 20 (e.g., a computer such as a portable PC, or a special output unit) for outputting logs of what has happened. Alternatively or additionally, the interface 18 can be used to send error messages to a separate monitoring system that is not dependent upon the server itself.

The additional bus interface 19 may, e.g., be an I2C/SMBUS interface. Its purpose is to provide a communication connection between the monitoring device microcontroller and the circuit board 110, especially in the case where the circuit board 110 is a motherboard in a computer which constitutes the equipment unit 100. The additional bus interface can easily be tailored to the motherboard in question in accordance with specifications for the motherboard. The aim is to supply data to already existing monitoring mechanisms and software which might be found in the computer (with associated operating system) which is constituted by the equipment unit 100.

Certain elements contained within the monitoring device, in particular the sensors 12, 13, 14, 15, can be supplied with electrical power from a battery 8 or from an external power supply 9, which in one example may be the power supply in the equipment unit (e.g., the computer/server) 100.

A switch 10 is arranged to choose between supply of power to the microcontroller 11 and the sensors 12, 13, 14, 15 from the battery 8 or from the power supply 9.

The switch 10 may be an electronic switch that automatically chooses the power supply 9 as source if it is active, and, if not, it chooses a battery as power supply.

An external power switch 2 is the on/off switch of the server/equipment unit. This is normally connected directly to the motherboard 110.

A single-use switch/override component 3 functions in such manner that it can only be activated once, and it should be possible to see that it has been activated even after a fire or other severe external stress. It may either be a switch that has a physical lock making it impossible to reset, or it may be a bridge component which is snapped off the printed board in order to obtain a similar effect.

An electronic relay 4 is provided for activating/deactivating the external power switch 2, and cooperates with the external power switch 2. The electronic relay 2 is adapted to ensure that it is not possible to turn the server on via the off/on switch 2 after an event that is determined by processing in the microcontroller 11.

As is further shown in FIG. 6, the equipment unit 100 is by way of example a computer, and in particular a server. The equipment element 110 is by way of example the server's motherboard. An operating system which is contained within a memory in the server, and which is executed by the server, is indicated by the figure element 6.

The server may further be provided with a server monitoring program, installed on the machine to monitor the server's components. One example is known as Supero Doctor III.

In addition to carrying out the process as exemplified above with reference to FIGS. 2, 3, 4 and 5, the microcontroller 11 may be configured to reduce the power consumption in connection with battery operation, such as putting the microcontroller in a sleeping mode after a predetermined timeout, and restoring a normal operating mode by activating a tilt, vibration or acceleration sensor 12.

The program that is executed by the microcontroller, and associated data used by the program, can be input/output/updated/upgraded by means of a communication port, e.g., the serial interface 18.

As is further indicated in FIG. 6, the microcontroller is connected to a warning device 1. As shown, the warning device 1 is connected via the electronic relay 4, but it may alternatively be connected to another output device linked to the microcontroller.

The warning device 1 may, in one example, be a light diode mounted on the front of the server/equipment unit 100. It may also be combined with an audio warning and/or an LCD-display for more detailed display of relevant information. The warning device indicates if the machine has been subjected to stresses that exceed the limit values, and/or that “the single-use switch has been activated”, as is apparent from the process as exemplified with reference to FIGS. 2, 3, 4 and 5. The warning device 1 may thus be associated with the warning that is mentioned with reference to, e.g., steps 408, 450, 506, 530, 542, 550 and 552.

If there is a need to operate the server in an “emergency mode”, as e.g., allowed in step 560, this should be done under continuous supervision and all precautions must be taken in accordance with special instructions.

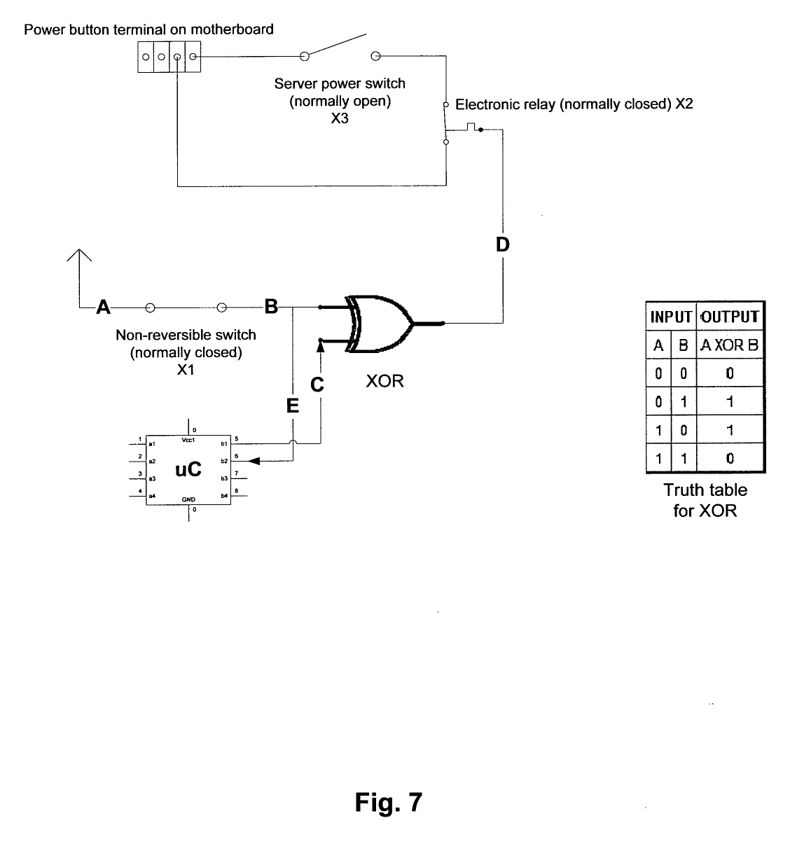

FIG. 7 is an exemplary block diagram which, in more detail, illustrates the principles of a non-reversible switch.

FIG. 7 is given as further explanation, and shows in principle the logical structure of the aforementioned non-reversible switch and its function. The drawing does not necessarily show the specific components that are to be used, but is a simplified overview of its function. Voltage levels are not given either, rather just logical levels represented as 1 and 0.

Scenario 1—Normal operation, no stress has occurred. The non- reversible switch is in its normal position:

### A=1, B=1, C=1, D=0

X1=Closed, X2=Closed, X3=Closed or open.
The server can be started

Scenario 2—The start-up lock is enabled in response to a stress which exceeds the limit values. X1 is not activated (still closed):

### A=1, B=1, C=0, D=1

X1=Closed, X2=Open, X3=Closed or open.

The server cannot be started.

Scenario 3—The start-up lock is enabled in response to a stress which exceeds the limit values. X1 is activated (open):

### A=1, B=0, C=0, D=0

X1=Open, X2=Closed, X3=Closed or open.

The server can be started in emergency mode.

E is used to tell the microcontroller that the non-reversible switch has been activated. X3 is a pulse switch that is used to turn the server on and off. If the start-up lock is enabled, it will open the relay X2 so that it switches off X3.

It should be understood that the monitoring device 120 can be configured as an integral part of the equipment unit 100 and in particular the element 110, or as an independent module that can be retrofitted in existing equipment.

Many modifications and adaptations of the present invention are possible within the scope of the claims.

1. A process for monitoring an equipment unit, carried out by a processing device in a monitoring device, the process comprising
reading at least one sensor signal;
determining, on the basis of the at least one sensor signal, whether the equipment unit has been subjected to an unacceptable stress;
if the equipment unit has been subjected to an unacceptable stress, enabling a start-up lock for the equipment unit and storing lock status information in a memory.

2. A process in accordance with claim 1,
further comprising
determining whether the monitoring device is operating in a low-power mode or a normal power mode, and
wherein said step of determining whether the equipment unit has been subjected to an unacceptable stress comprises criteria that are dependent upon whether the monitoring device is operating in a low-power mode or a normal power mode.

3. A process in accordance with claim 1 or 2, further comprising
receiving a signal which indicates that the equipment unit is to be started up;
determining whether said start-up lock has been enabled; and
if said start-up lock has been enabled, activating a warning.

4. A process in accordance with claim 3, further comprising
if said start-up lock has been enabled, determining whether a non-reversible switch has been activated; and
if said non-reversible switch has not been activated, maintaining said warning and preventing further operation of the equipment unit.

5. A process in accordance with claim 4, further comprising
if said non-reversible switch has been activated, determining whether a switch for deactivating the warning has been activated; and
if said switch for deactivating said warning has been activated, deactivating said warning.

6. A process in accordance with claim 5, further comprising
if said switch for deactivating said warning has not been activated, allowing the equipment unit to be in operation in an emergency mode.

7. A process in accordance with one of claims 1-6,
wherein said equipment unit is a computer,
wherein said monitoring device is arranged on a printed circuit board in said computer, and wherein said at least one sensor signal is provided from at least one sensor arranged in said monitoring device.

8. A process in accordance with claim 7,
wherein said at least one sensor comprises an acceleration sensor, and
wherein said step of determining whether the equipment unit has been subjected to an unacceptable stress, comprises ascertaining whether said sensor signal exceeds a limit value contained within said memory.

9. A process in accordance with claim 8,
wherein said at least one sensor comprises further comprising at least one additional sensor selected from the group consisting of:
temperature sensors, humidity/moisture sensors, optical dust or dirt sensors.

10. A process in accordance with claim 2,
wherein, in the low-power mode, one set of sensor signals is used in determining whether the equipment unit has been subjected to an unacceptable stress, whilst in a normal power mode another set of sensor signals is used to determine whether the equipment unit has been subjected to an unacceptable stress.

11. A process in accordance with claim 10,
wherein, in the low-power mode, it is determined that the equipment unit has been subjected to an unacceptable stress if an acceleration sensor signal, or a tilt sensor signal, exceeds a limit value.

12. A process in accordance with claim 11,
wherein, in a normal effect mode, it is determined that the equipment unit has been subjected to an unacceptable stress if the acceleration sensor signal exceeds the limit value, and another sensor signal, sea temperature sensor, humidity/moisture sensor optical dirt/dust sensor(s) exceeding

13. A set of processing instructions, comprising
instructions, contained within a memory, a medium or carried by a propagated signal, which, when executed by a processing device in a monitoring device, perform a process as disclosed in one of claims 1-12.

14. A monitoring device comprising
input circuits, output circuits, a processing device and a memory, connected via at least one bus, wherein the processing device is configured to execute a set of processing instructions as disclosed in claim 13, the processor instructions being contained within said memory.

15. An equipment unit, comprising a monitoring device as disclosed in claim 14.
